(19) United States
(12) Patent Application Publication
(10) Pub. No.: US 2004/0243986 A1
(43) Pub. Date: Dec. 2, 2004

(54) Interpreter and native code execution method

(75) Inventor: Hiroyasu Nishiyama, Kawasaki (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/696,280

(22) Filed: Oct. 29, 2003

(30) Foreign Application Priority Data
Apr. 1, 2003 (JP) 2003-097574

(51) Int. Cl. G06F 9/45

(52) U.S. Cl. 717/139

(57) ABSTRACT

An interpreter for executing a programming language is equipped with a native code calling function. The interpreter calls native code and executes the native code by an emulation layer that performs emulation through hardware. The emulation layer monitors memory access instructions made by the native code to check if there are any illegal memory accesses, and manages information of execution states of portion of the native code, such that the execution states of the portion of the native code can be saved and restored.

### BACKGROUND OF THE INVENTION

1. Field of the Invention

The present invention generally relates to a method of executing a program written in a programming language which is executed with an interpreter having a native code calling function.

2. Related Background Art

There are known methods for executing programming languages. Those methods include a method that converts a source program into machine code to be executed by a target computer by using a program called a compiler, a method that uses a program called an interpreter to interpret and execute a source program or a program in intermediate representation that is converted from the source program, etc.

An interpreter is a general term for programs that execute other programs, and execution methods using an interpreter are often used in order to improve the portability of the programs. In a programming language that is used with an interpreter (which is referred hereafter to as an “interpreter type language”), since a program is executed by a program called an interpreter, it would be easy to detect problems such as illegal memory accesses that may occur with the program that is executed by the interpreter. Such programming languages can be represented by the Java® programming language. Applications that are written in the Java programming language are first converted into intermediate representation called byte code, and then the byte code is interpreted and executed by software called a Java virtual machine.

The Java programming language is characterized in that it includes a function to detect out-of-array memory reference and null pointer reference at the time of program execution, such that illegal memory corruption does not occur. On the other hand, in programs whose native code is executed, for example, programs written in other languages, such as, C and C++, sections of the memory outside the range that is protected by the operating system can be illegally accessed because these programming languages are not equipped with a function to protect memory.

With an interpreter type language such as the Java programming language, it is generally difficult to describe low-level library functions such as I/Os. Such low-level functions may be implemented in programs by a widely prevailing method that uses native code written in a programming language such as C or C++. For example, the Java programming language stipulates a specification called the Java Native Interface (JNI) for writing methods in native code, which a user wants to call from a program. The JNI stipulates specifications not only for calling native code from a Java program, but also for calling a Java program from native code.

In the mean time, there may be a case where, while executing an application program, the application program is desired to be temporarily stopped and saved in a file and later executed (i.e., checkpoint/restart) for purposes of maintaining or managing the program itself or hardware that runs the program. Also, for the same purposes, there may be a case where an application that is being executed on a hardware device is desired to be migrated to another hardware device to be continuously executed (i.e., migration). In these cases, the current state of the program being executed needs to be retrieved, saved and restored.

The Java programming language can provide a method to save and restore the current byte code execution state of a program. According to the method, sections of byte code are analyzed, codes for obtaining information such as values on the stack with respect to a program point to be saved are inserted in the byte code stream; and when the execution state of the program is to be restored, the sections of byte code are converted to re-structure the state of the program that has been saved.

The function to implement sections of a program by using native codes is indispensable when functions that cannot be implemented by the interpreter alone are to be realized. However, this function entails the following problems:

(1) Insufficient Guarantee for Security

Memory within the interpreter can be freely accessed by portions of the program in native code. Therefore, even the interpreter portion checks illegal memory accesses, the stability and security of the program cannot be guaranteed when the program has an error in its native code portions.

(2) Difficulty of Saving and Restoring State

For portions of a program which are executed by the interpreter, the interpreter manages states (data values on memory, addresses of instructions being executed, etc.) of the program being executed, and therefore the execution state of those portions can be readily saved and restored. On the other hand, since portions of the program to be executed in native code which are called from the interpreter are executed outside the management of the interpreter, it is difficult to save and restore the execution state of such portions of the program.

For example, in the conventional technology described above, saving and restoring execution states of programs are limited to applications that operate purely with Java executions. Generally, Java libraries include many portions that are implemented in native code, which cause a substantial restriction on saving and restoring execution states of programs.

The problems described above are caused because portions of programs in native code are executed regardless of the control of the interpreter.

### SUMMARY OF THE INVENTION:

In view of the above, in accordance with an embodiment of the present invention, native code portions of a program that are called from an interpreter are not directly executed by hardware, but by an emulator that performs emulation through the hardware (i.e., hardware emulation). As a result, the interpreter can control processing of native code.

The emulator may check memory accesses by the native code portions. As a result, occurrence of illegal memory accesses can be detected during execution of the native code.

Similarly, the emulator may record changes in the execution state of the program at the native code portions. As a result, the execution states can be saved and restored.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 schematically shows an interpreter system in accordance with an embodiment of the present invention.

FIG. 2 schematically shows a conventional interpreter system.

FIG. 3 shows a flowchart of a processing to execute a program by an interpreter in accordance with the present embodiment.

FIG. 4 shows a flowchart in detail of a processing 308 in FIG. 3.

FIG. 5 shows an example of a region table.

FIGS. 6 (a) and 6 (b) show an examples of a program.

FIG. 7 shows a flowchart of a processing to save a state.

FIG. 8 shows a flowchart of a processing to restore the saved state.

FIGS. 9 (a) and (b) show an example of a Java program that is subject to saving and restoring.

FIG. 10 shows an example of information that is saved.

FIG. 11 shows a hardware structure of a system that executes an interpreter.

FIG. 12 shows a flowchart of a processing to save a state at the time of emulation of an instruction.

FIG. 13 shows a flowchart in detail of a processing 703 shown in FIG. 7.

### DETAILED DESCRIPTION OF THE PREFERRED EMBODIMENTS

A preferred embodiment of the present invention is described below with reference to the accompanying drawings.

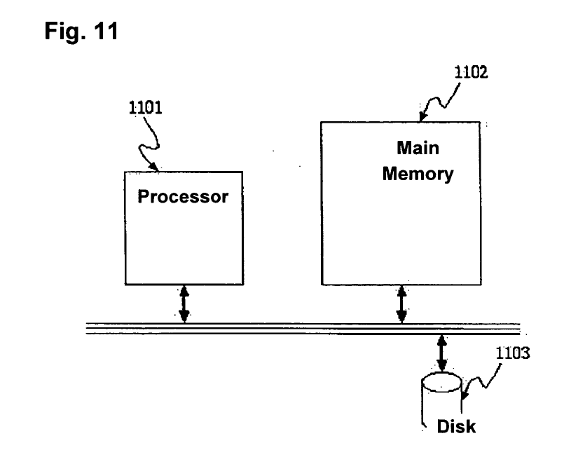

FIG. 11 shows an example of a hardware structure of a system that executes an interpreter in accordance with an embodiment of the present invention. The interpreter may be stored in a disk device 1103. The interpreter is read from the disk device 1103 onto a main storage device 1103, and executed on a processor 1101. Applications that are executed by the interpreter are also stored in the disk device 1103. The application is read onto the main storage device 1103, and executed by the interpreter that operates on the processor 1101. The interpreter may be stored in recording media such as a floppy disk (FD), a CD-R or the like for handling and transportation. The interpreter may be read out from the recording media by a media reading device (not shown) and stored in the disk device 1103 before execution of the applications.

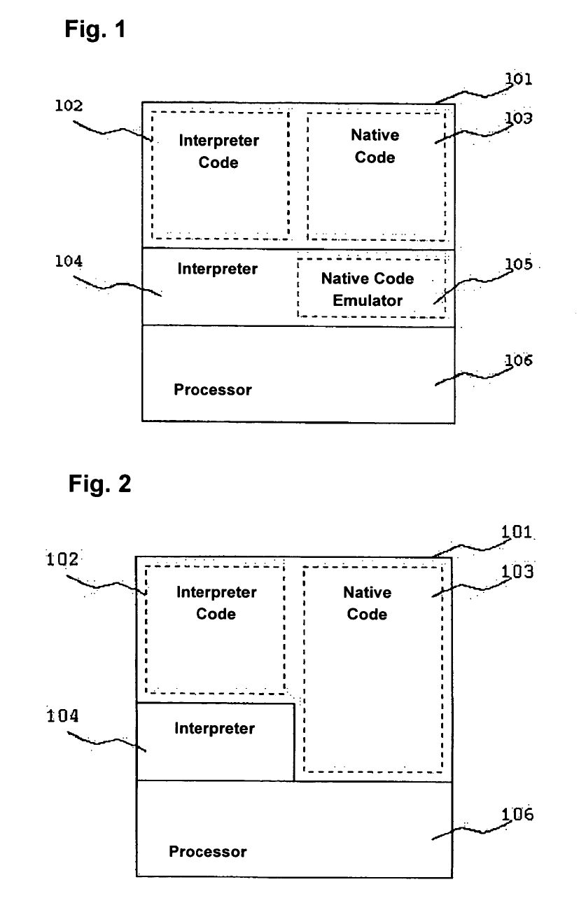

FIG. 2 shows an example of a conventional interpreter system. An application program 101 is typically composed of interpreter codes 102 and native codes 103. The interpreter codes 102 are interpreted and executed by an interpreter 104 on a processor 106.

FIG. 1 schematically shows an interpreter system in accordance with an embodiment of the present invention. An application program 101 is typically composed of interpreter code 102 and native code 103. The interpreter code 102 is interpreted and executed by an interpreter 104 on a processor 106 in the same manner as the conventional method does. On the other hand, the native code 103 is executed through a native code emulator 105. When native code is executed by an emulator, the execution speed may be lowered compared to a system that directly executes native code on a processor. However, an appropriate technique, such as, for example, a binary translation technique that dynamically generates machine code at the time of execution, may be used to limit the deterioration of the execution performance. In embodiment examples to be described below, the interpreter is equipped with a native code emulator. However, the interpreter may be equipped only with a function to call a native code emulator, and the interpreter and the native code emulator may be provided as independent programs.

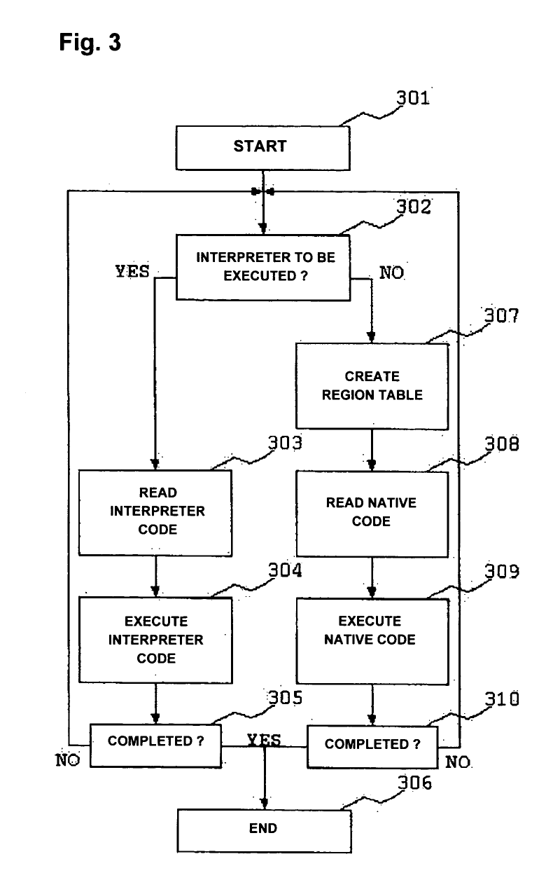

FIG. 3 shows a flow of processings to execute a program by the interpreter in accordance with the present embodiment. When execution of a program is started in step 301, a determination is made in step 302 as to whether a code to be executed is an interpreter code or a native code. When the code is determined to be an interpreter code, the control shifts to step 303 where the interpreter code to be processed is read from the memory. Then, the interpreter code read is executed in step 304, and a determination is made in step 305 as to whether the execution of the program is completed. When the execution of the program is determined completed, the control shifts to step 306, and the execution of the program is ended. When the execution of the program is not completed, the processing returns to step 302, and the next code is executed.

In step 302, if the code is determined to be a native code, the control shifts to step 307 where a region table is created. The region table represents information concerning memory regions that are accessible or inaccessible from the native code. Next, the control shifts to step 308. In step 308, the native code is read out from the memory, examination is additionally conducted to check accessibility or inaccessibility of memory regions by referring to the region table created in step 307. If no access error is found in the examination, the native code read in step 308 is executed in step 309. Next, a determination is made in step 310 as to whether the execution of the program is completed. When the execution of the program is determined completed, the control shifts to step 306, and the execution of the program is ended. When the execution of the program is not completed, the processing returns to step 302, and the next code is executed.

It is noted that, in the flowchart shown in FIG. 3, the region table is generated before the native code is executed. However, in another embodiment example, a region table may be initially set at the time of starting up a program, and the region table may be updated each time the region accessible from a native code is changed with the execution of the program.

The method in which a region table is created before execution of a native code has the advantage in that a memory to be used for the region table is not required when a native code is not called. However, the overhead to call each native code becomes greater. On the other hand, in the later method in which a region table is updated with the execution of a program, the overhead to call each native code may be reduced, but the data of the region table needs to be stored during execution of the program.

The processing flow in FIG. 3 shows an example in which, for each interpreter code and each native code, a determination is made at execution of each instruction as to whether the next target code to be executed belongs to an interpreter code or a native code. However, in other cases where transition between execution of an interpreter code and execution of a native code is performed by a specified instruction, in other words, where the classification of the next target instruction can be specified, such determination operations may be omitted. For example, since transition from an interpreter code to a native code is limited to occurrence of a native method call in the Java programming language, execution can be assumed to be execution of interpreter codes until such time when a native method call occurs, and therefore the examination in step 302 can be omitted.

Assurance of security at the time of executing native programs, and recording of execution states of the native programs for saving and restoring the execution states, which are characteristic functions of the embodiment example of the present invention, are mainly performed in step 308.

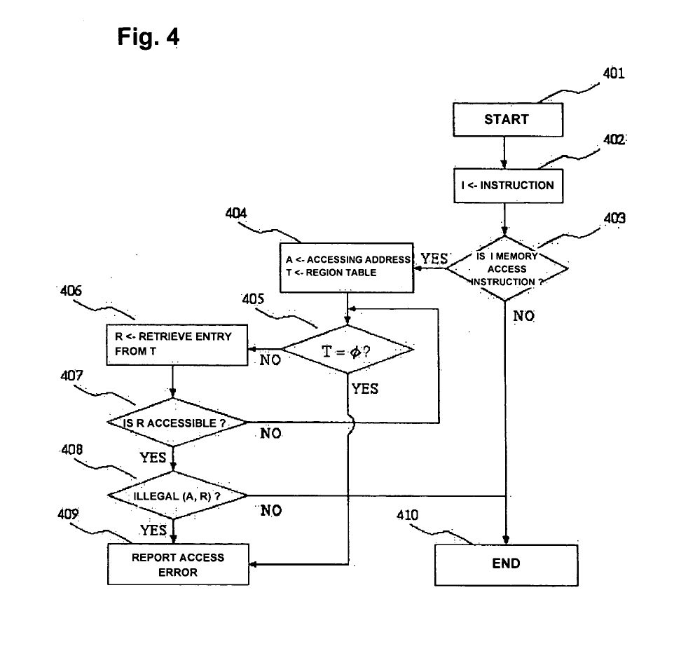

FIG. 4 shows an example in detail of a processing to detect illegal memory access and destruction, which is performed in the native code read processing in step 308. First, the processing starts in step 401. In step 402, a target instruction to be executed is obtained as a variable I. Next, in step 403, whether or not the target instruction I to be executed is a memory access instruction is confirmed. When the target instruction I is not a memory access instruction, the control shifts to step 410, and the processing is completed (in other words, the processing in step 308 is completed, and the native code is executed in step 309). When the target instruction I is a memory access instruction, the control shifts to step 404, where an address to be accessed by the instruction I is obtained as a variable A, and a region table representing information of accessible memory regions is obtained as a variable T. Next, in step 405, whether the region table is empty or not is confirmed. When the region table is empty, which means that the corresponding address is not registered, the control shifts to step 409 in which an access error is reported. When the region table is not empty, the control shifts to step 406, where one of the entries (regions) listed in the region table T is retrieved from the region table T, and stored in a variable R. Then, it is confirmed in step 407 as to whether or not the address A is included in the region information R. If the address A is not included in the region information R, the address A is not referred to, and the control returns to step 405, and the examination of the next region is continued. If the address A is included in the region information R, the control shifts to step 408 to confirm as to whether an access to the address A is illegal or not. If the access is illegal, the control shifts to step 409, and the processing is ended. If the access is not illegal, the control shifts to step 410, and the processing is completed.

The region table that defines information concerning memory regions to be used in the processing described above may be defined based on the execution state of portions executed by the interpreter. In the case of a Java interpreter, in principle, native code executing portions cannot read from or write in memory regions that are under the control of the Java interpreter. However, they can read or write through JNI functions.

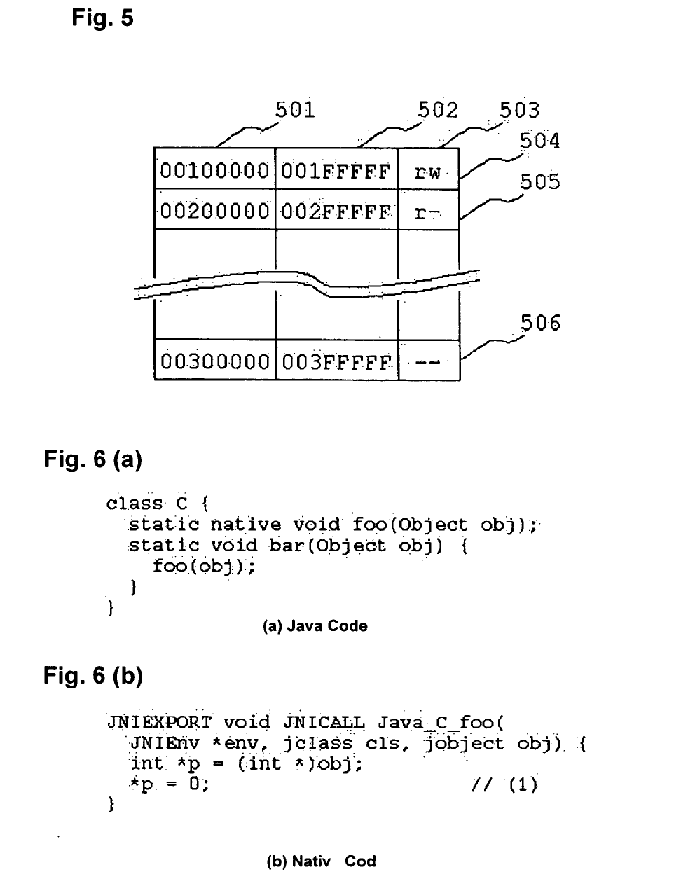

FIG. 5 shows an example of the region table. In this example, the table is composed of three entries, i.e., starting address 501, ending address 502, and accessible mode 503. In the accessible mode 503, “r” indicates that a corresponding region is readable, “w” indicates that a corresponding region is writable, and “--” indicates that a corresponding region is not either readable or writable. For example, let us consider a case when a storing instruction performs writing at an address 00310000. In this case, the entries 504-506 in the region table in FIG. 5 are successively examined through the processings in step 405 through 407. At the entry 506, it is determined that the region to which the address 00310000 belongs is not writable, and therefore an error is reported in step 409. Next, let us consider a case when a loading instruction performs reading at an address 00220000. Similarly to the example described above, the entries 504-506 in the region table in FIG. 5 are successively examined through the processings in step 405 through 407. At the entry 505, it is determined that the region to which the address 00220000 belongs is readable, and the processing normally ends in step 410.

The examination described above does not have to be performed for every memory reference, and can be omitted when it is obvious that an access is not an illegal access or an access is redundant.

FIGS. 6 (a) and 6 (b) show an example of a Java program that performs such an illegal reference. In the Java program in FIG. 6 (a), a reference (i.e., address) of an object is given to a native method foo. In a native method in FIG. 6 (b), the given address of the object is cast to an int-type pointer, and an illegal writing to the object is made in line (1). Since the target object to be written is under the control of the interpreter, the target object cannot be referred to from the native code executing portion, as described above. As a result, an error detection is made at the native code executing portion.

Next, an embodiment example of saving and restoring execution states of a program will be described.

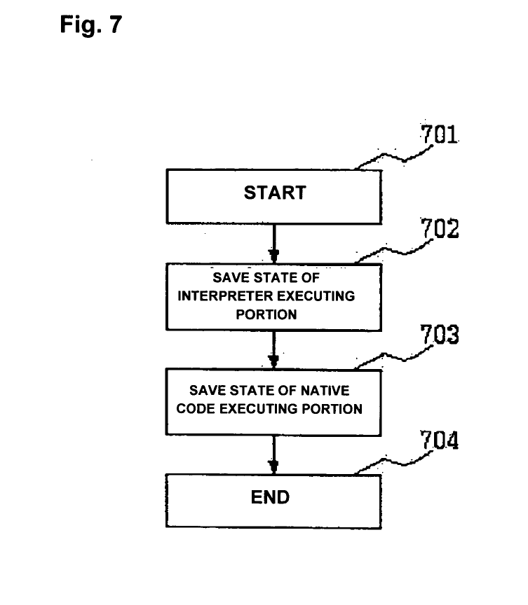

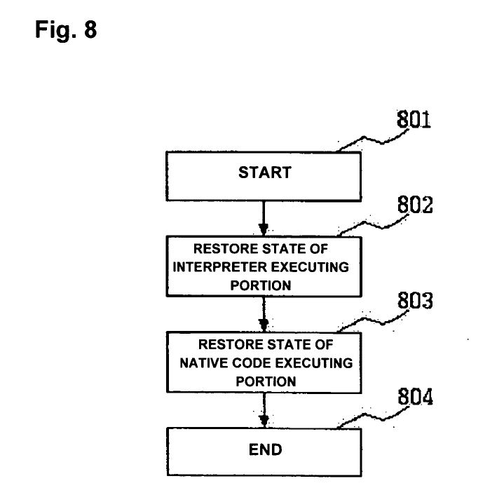

FIG. 7 shows a state saving processing. The state saving processing starts in step 701. Next, the execution state of the interpreter executing portion is saved in step 702, the execution state of the native code executing portion is saved in step 703, and the state saving processing is completed in step 704. FIG. 8 shows a restoring processing to restore the saved states. The restoring processing is performed in a processing order similar to that of the state saving processing. For example, first, the restoring processing starts in step 801, then the execution state of the interpreter executing portion is restored in step 802, the execution state of the native code executing portion is restored in step 803, and the restoring processing is completed in step 804.

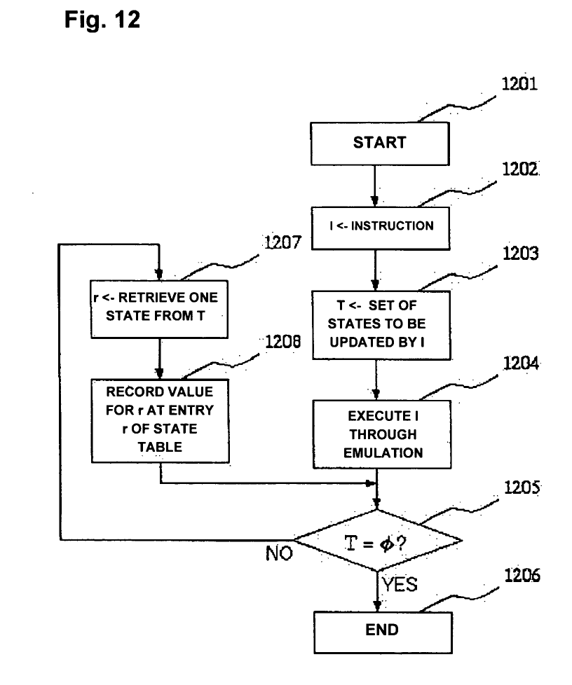

FIG. 12 shows a flowchart of an instruction emulation processing to record information for saving the execution state of the native code executing portion. The instruction emulation processing starts in step 1201, and then in step 1202, the target instruction to be executed is obtained as a variable I. Then, in step 1203, a set of states to be updated by the instruction I is obtained as a variable T. Generally, the set of states to be updated by the instruction I is defined by the instruction specification of a processor that is subject to the emulation. Next, in step 1204, the instruction I is executed through emulation. As a result, the set of states obtained in step 1203 is updated. After executing the instruction, whether or not the set of states T is empty or not is confirmed in step 1205. If the set of states T is empty, the control shifts to step 1206, and the processing is completed. If the set of states T is not empty, the control shifts to step 1207, where one of the states is retrieved from the set of states T. Then, an update value of the state retrieved in step 1207 is recorded in a state table in step 1208. By this step, the latest value of the state to be updated by the native code executing portion is recorded in the state table. Then, the control shifts to step 1205, and the next state is similarly processed. It is noted that, in the example indicated in FIG. 12, an update value of each state is saved in the state table at each instruction. However, a plurality of instructions may be processed at once since recording of only the last values in the state table is sufficient.

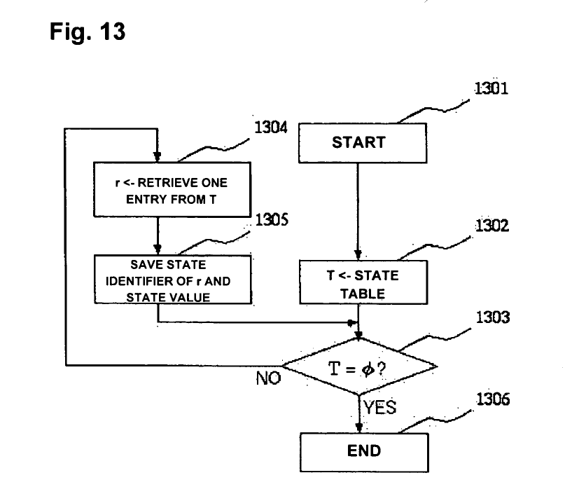

Next, FIG. 13 shows details of the state saving processing in step 703. The processing indicated in FIG. 13 is started in step 1301, and a state table is obtained as a variable T in step 1302. Next, whether the state table is empty or not is confirmed in step 1303. If the state table is empty, the control shifts to step 1306, and the processing is completed. If the state table is not empty, one of the entries (i.e., states) in the state table T is retrieved from the state table T, and stored in a variable r. Then, a state identifier for the state r and the latest value stored in the state table are saved in step 1305. Next, the control shifts to step 1303, and the next state is similarly processed.

In the state restoring processing in step 803, in reverse of the above state saving processing, the saved state table is read, and the latest values indicated by the state identifiers can be used.

Through the processing steps described above, the latest state at the time of executing the native code portion can be recorded in the state table, and therefore the state of the native code executing portion can also be saved and restored.

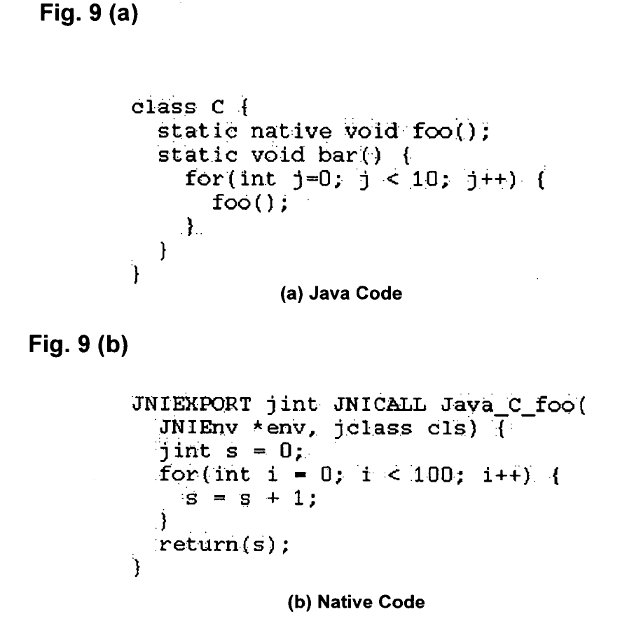

FIGS. 9 (a) and 9 (b) show an example of a Java program that is subject to the saving and restoring processings. In this example, a native code in FIG. 9 (b) is called from a Java program in FIG. 9 (a). Here, this example shows a case where the execution state of the program is saved and restored at the start of the third loop repeated in the Java code portion and at the start of the tenth loop repeated in the native code portion.

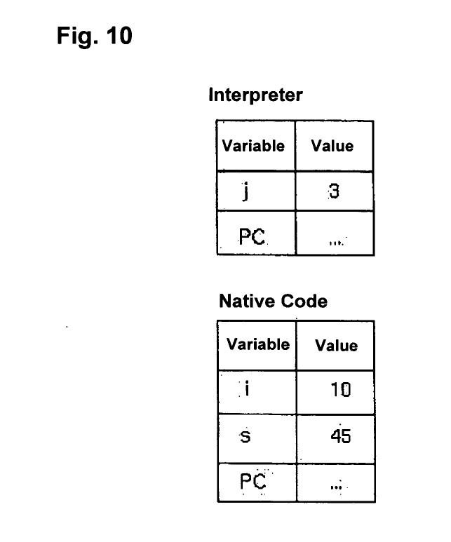

An example of information that is saved in the above example is shown in FIG. 10. In this example, only values of the variables are shown for simplification of illustration. However, in effect, a variety of information including execution addresses of the program and the like needs to be added. It is noted that, according to the conventional method, values of variables in portions executed by an interpreter at the time the program is stopped can be detected, but the state of native code executing portions is not known. However, by executing native code portions by an emulator in accordance with the present embodiment, values of the execution state of the native code portions, as shown in FIG. 10, can be saved. When the state of the program is to be restored, the values indicated in FIG. 10 may be read as needed for restoring the state of the program.

In accordance with the present invention, illegal memory accesses that may occur by native codes that are called from a program executed by an interpreter can be detected. Also, execution states of a program that calls native codes can be saved and restored.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An interpreter that executes a program written in a programming language in cooperation with a processor, the interpreter comprising:
a module that calls a native code; and
a native code emulator that executes the native code through hardware emulation.

2. An interpreter according to claim 1, wherein the native code emulator includes a monitoring module to monitor a memory access instruction by the native code.

3. An interpreter according to claim 1, further comprising a table for memory regions that are managed by the interpreter wherein the table records information as to whether or not each of the memory regions is accessible from the native code.

4. An interpreter according to claim 3, wherein the table records information as to whether or not each of the memory regions is readable, writable or executable from the native code.

5. An interpreter according to claim 3, wherein, when the native code emulator executes the native code, the monitoring module refers to the table to detect an illegal reference that is made when the memory access instruction is executed.

6. An interpreter according to claim 1, further comprising a determination module that makes a determination as to whether a target code in a program to be executed is an interpreter code or a native code, wherein, when the target code is determined to be a native code, the native code emulator processes the native code.

7. An interpreter according to claim 6, wherein, when transition between execution of an interpreter code and execution of a native code is performed by a native method call, the determination module does not make the determination until a native method call occurs.

8. An interpreter according to claim 1, wherein the native code emulator stores execution state of portion of the native code.

9. An interpreter according to claim 8, wherein internal state of the interpreter and the execution state of the portion of the native code are saved when the program is stopped and execution state of the program is saved.

10. An interpreter according to claim 9, wherein the execution state of the program saved is read out to restart execution of the program from a point where the program is stopped.

11. An interpreter that executes a programming language in cooperation with a processor, the interpreter comprising:
a module that calls a native code; and
a monitoring module that monitors a memory access instruction by the native code.

12. An interpreter according to claim 11, further comprising a table for memory regions that are managed by the interpreter wherein the table records information as to whether or not each of the memory regions is accessible from the native code.

13. An interpreter according to claim 12, wherein the table records information as to whether or not each of the memory regions is readable, writable or executable from the native code.

14. An interpreter according to claim 11, further comprising a native code emulator that executes the native code through hardware emulation.

15. An interpreter according to claim 14, wherein, when the native code emulator executes the native code, the monitoring module refers to the table to detect an illegal reference that is made when the memory access instruction is executed.

16. A native code execution method for an interpreter that has a native code calling function and executes a programming language in cooperation with a processor, the native code execution method comprising the steps of:
calling a native code; and
executing the native code by a native code emulator through hardware emulation.

17. A native code execution method according to claim 16, wherein the native code is not directly executed by hardware.

18. A native code execution method according to claim 17, further comprising the step of monitoring a memory access instruction by the native code.

19. A native code execution method according to claim 18, further comprising the steps of creating a table of memory regions that are managed by the interpreter, and recording in the table information as to whether or not each of the memory regions is accessible from the native code.

20. A native code execution method according to claim 19, wherein the table records information as to whether or not each of the memory regions is readable, writable or executable from the native code.

21. A native code execution method according to claim 20, further comprising the step of, when the native code emulator executes the native code, referring to the table to detect an illegal reference that is made when the memory access instruction is executed.
